(19) United States
(12) Patent Application Publication
(10) Pub. No.: US 2026/0021816 A1
(43) Pub. Date: Jan. 22, 2026

(54) System for Anti-Theft Braking and Related Methods

(71) Applicant: ZF Friedrichshafen AG, Friedrichshafen (DE)

(72) Inventor: Kasi Viswanadh Pedapati, West Godavari (IN)

(21) Appl. No.: 18/773,679

(22) Filed: Jul. 16, 2024

(51) Int. Cl. B60W 40/08

(52) U.S. Cl. CPC B60W 40/08; B60W 2040/0809; B60W 2420/40

(57) ABSTRACT

A system includes memory hardware configured to store instructions and processor hardware configured to receive, from a sensor, data associated with a driver of a vehicle and execute the instructions. The instructions include identifying the driver of the vehicle based on the data. The instructions include, in response to identifying the driver, determining if the driver is an authorized driver or an unauthorized driver. The instructions include, in response to determining that the driver is the unauthorized driver, sending an authorization request to a user device of an owner of the vehicle. The instructions include, in response to the owner rejecting the authorization request or failing to respond to the authorization request within a determined time period, automatically activating at least one of: a brake of the vehicle, a horn or a speaker of the vehicle, or a steering lock of the vehicle.

### FIELD

The present disclosure relates to a system for anti-theft braking and more particularly to a system for anti-theft braking that may be used in connection with vehicles.

### BACKGROUND

Over a million vehicles were stolen last year in the United States alone. Vehicle theft causes significant financial losses to both vehicle owners and insurance companies, often leading to higher insurance premiums for everyone. Vehicle theft results in considerable inconvenience and emotional distress for victims, disrupting their daily lives and routines. Stolen vehicles are frequently used in other criminal activities, compounding public safety concerns. Further, the economic impact of vehicle theft extends to communities, affecting local economies and law enforcement resources. While known anti-theft systems have proven acceptable for their intended purpose, a continuous need for improvement remains in the pertinent art.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

One aspect of the disclosure provides a system. The system includes memory hardware configured to store instructions and processor hardware configured to receive, from a sensor, data associated with a driver of a vehicle and execute the instructions. The instructions include identifying the driver of the vehicle based on the data. The instructions include, in response to identifying the driver, determining if the driver is an authorized driver or an unauthorized driver. The instructions include, in response to determining that the driver is the unauthorized driver, sending an authorization request to a user device of an owner of the vehicle. The instructions include, in response to the owner rejecting the authorization request or failing to respond to the authorization request within a determined time period, automatically activating at least one of: a brake of the vehicle to restrict the vehicle from moving, a horn or a speaker of the vehicle, or a steering lock of the vehicle to restrict the vehicle from steering.

Another aspect of the disclosure provides a computer-implemented method. The method includes receiving, from a sensor, data associated with a driver of a vehicle. The method includes identifying the driver of the vehicle based on the data. The method includes, in response to identifying the driver, determining if the driver is an authorized driver or an unauthorized driver. The method includes, in response to determining that the driver is the unauthorized driver, sending an authorization request to a user device of an owner of the vehicle. The method includes, in response to the owner rejecting the authorization request or failing to respond to the authorization request within a determined time period, automatically activating at least one of: a brake of the vehicle to restrict the vehicle from moving, a horn or a speaker of the vehicle, or a steering lock of the vehicle to restrict the vehicle from steering.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a schematic view of an example system for anti-theft braking in accordance with the principles of the present disclosure.

FIG. 2A is a perspective view of operating the system of FIG. 1 in accordance with the principles of the present disclosure.

FIG. 2B is a front view of operating the system of FIG. 1 in accordance with the principles of the present disclosure.

FIG. 3 is a graphical representation of example data structures that may be stored in a database of the system of FIG. 1 in accordance with the principles of the present disclosure.

FIGS. 4A and 4B depict a flowchart of an example method for operating the system of FIG. 1 in accordance with the principles of the present disclosure.

In the drawings, reference numbers may be reused to identify similar and/or identical elements.

### DETAILED DESCRIPTION

### Introduction

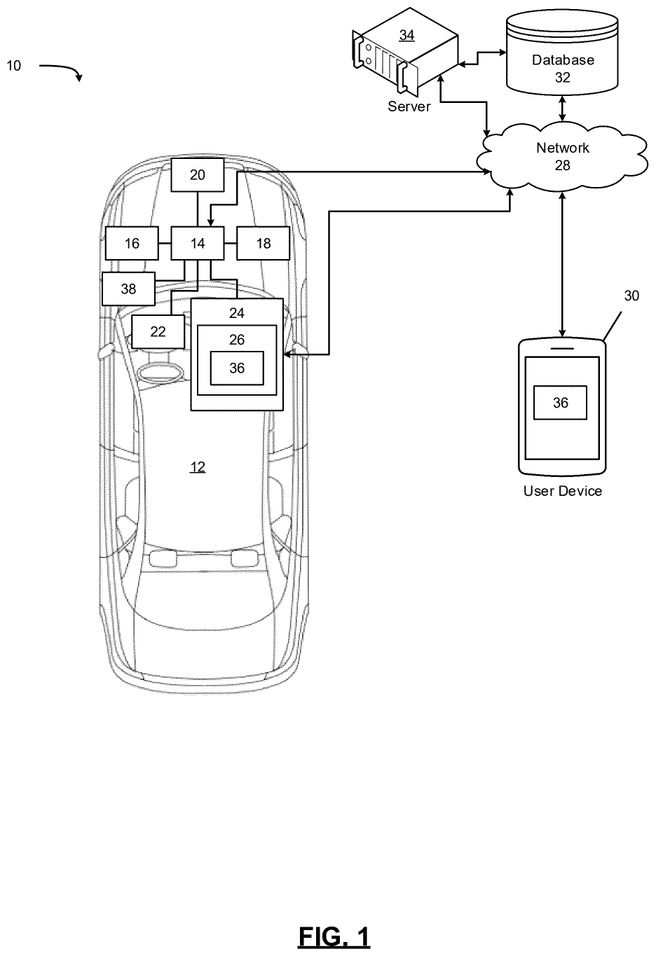

With reference to FIG. 1, an example system 10 for anti-theft braking is shown. In various implementations, the system 10 may include and/or may be incorporated with a vehicle 12 (e.g., an automobile). In various implementations, the system 10 may include a controller 14, a braking system 16, a parking brake system 18, a horn system 20, at least one sensor 22, an infotainment system 24 having a display 26, at least one network 28, at least one user device 30, at least one database 32, at least one server 34, at least one software application 36, and/or a steering lock system 38, among others.

### Controller

With continued reference to FIG. 1, in various implementations, the controller 14 may be electrically and/or communicatively coupled with the braking system 16, the parking brake system 18, the horn system 20, the sensor 22, the infotainment system 24, and/or the steering lock system 38, among others. In various implementations, the controller 14 may be communicatively coupled to the user device 30, the database 32, and/or the server 34 via the network 28. In various implementations, the controller 14 may control operation of the braking system 16, the parking brake system 18, the horn system 20, the infotainment system 24, and/or the steering lock system 38, among others. In various implementations, the controller 14 may receive data and information from the sensor 22.

In various implementations, the controller 14 includes an electronic controller and/or an electronic processor, such as a programmable microprocessor and/or microcontroller. The controller 14 may include an application specific integrated circuit (ASIC). The controller 14 may include a central processing unit (CPU), a memory (e.g., a non-transitory computer-readable storage medium), and/or an input/output (I/O) interface. The controller 14 may perform various functions, including those described in greater detail herein, with appropriate programming instructions and/or code embodied in software, hardware, and/or other medium. The controller 14 may include a plurality of controllers. The controller 14 may be connected to a display (e.g., display 26), such as a touch screen.

### Braking System

With continued reference to FIG. 1, in various implementations, the braking system 16 may restrict the vehicle 12 from moving when in an activated state and may permit the vehicle 12 to move when in a deactivated state. In various implementations, the braking system 16 may include an electric vehicle braking system (EVBS) such as a brake-by-wire system, a hydraulic braking system, a mechanical braking system, and/or a combination thereof, among others.

In various implementations, the braking system 16 may transmit data and/or information to the controller 14 and/or may receive control signals from the controller 14. In various implementations, the controller 14 may selectively cause the braking system 16 to be in the activated state or the deactivated state.

### Parking Brake System

With continued reference to FIG. 1, in various implementations, the parking brake system 18 may restrict the vehicle from moving when in an activated state and may permit the vehicle 12 to move when in a deactivated state. In various implementations, the parking brake system 18 may include an electronic parking brake (EPB), among others.

In various implementations, the parking brake system 18 may transmit data and/or information to the controller 14 and/or may receive control signals from the controller 14. In various implementations, the controller 14 may selectively cause the parking braking system 18 to be in the activated state or the deactivated state.

### Horn System

With continued reference to FIG. 1, in various implementations, the horn system 20 may output an audible sound (e.g., via a horn and/or a speaker, among others) when in an activated state and may not output an audible sound when in a deactivated state. In various implementations, the horn system 20 may include an electronic horn system. In various implementations, the horn system 20 may transmit data and/or information to the controller 14 and/or may receive control signals from the controller 14. In various implementations, the controller 14 may selectively cause the horn system 20 to be in the activated state or the deactivated state.

### Sensor

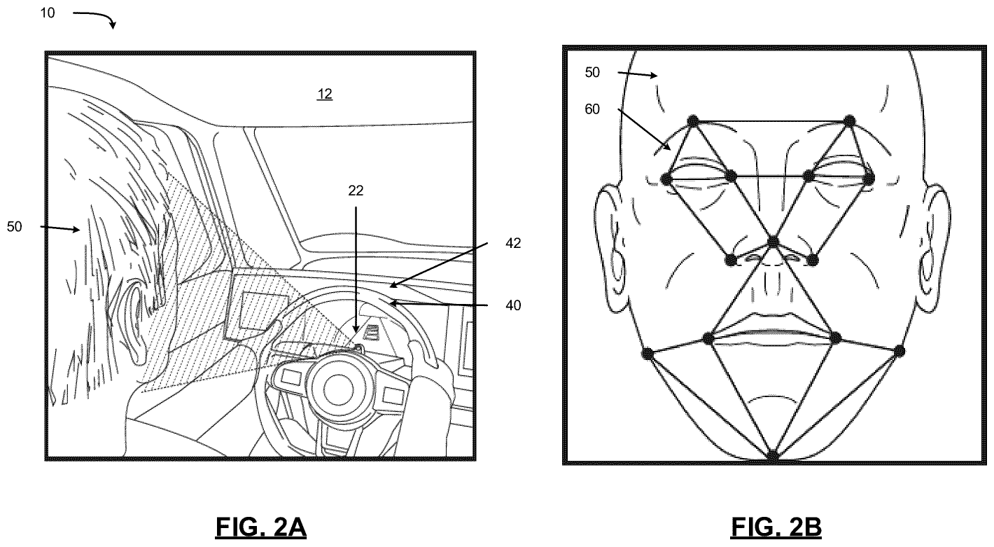

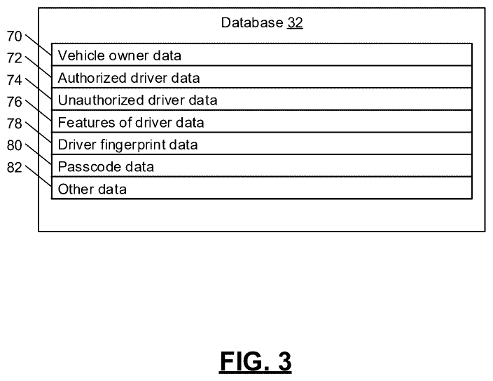

With reference to FIGS. 1 and 2A, in various implementations, the sensor 22 may include an infrared light-emitting diode and/or a camera, among others. In some example configurations, the sensor 22 may be disposed proximate a steering wheel 40 of the vehicle 12. For example, the sensor 22 may be connected to the steering wheel 40 or a dash 42 of the vehicle 12, among others. In various implementations, the sensor 22 collects data and/or information associated with a driver 50 of the vehicle 12. The sensor 22 transmits the collected data and/or information to the controller 14.

Referring now to FIG. 2B, in various implementations, the controller 14 may determine the identity of the driver 50 based on data from the sensor 22. For example, the controller 14 may determine a set of features 60 that help facilitate the identification of the driver. The set of features 60 may include eye shape, eye color, eye position, nose shape, nose size, mouth shape, mouth size, chin shape, chin size, and/or fingerprint, among others.

In various implementations, the controller 14 may use the identity of the driver to determine if the driver 50 is authorized to operate the vehicle 12 or if the driver 50 is unauthorized to operate the vehicle 12. For example, the controller 14 may determine if the driver 50 is the vehicle owner, if the driver 50 has authorization to operate the vehicle 12, and/or if the driver 50 is not authorized to operate the vehicle 12.

### Infotainment System

Referring again to FIG. 1, in various implementations, the infotainment system 24 may transmit data and/or information to the controller 14 and/or may receive control signals from the controller 14. In various implementations, the infotainment system 24 may be communicatively coupled to the user device 30, the database 32, and/or the server 34 via the network. For example, the infotainment system 24 may transmit information to and/or may receive information from the user device 30, the database 32, and/or the server 34 via the network 28. In various implementations, the infotainment system 24 may execute the application 36. As will be explained in further details below, a user (e.g., the driver 50, a passenger, etc.) may operate the application 36 via the display 26 (e.g., a user interaction display) when the user is located in the vehicle 12.

### Network

With continued reference to FIG. 1, in various implementations, the vehicle 12 is communicatively coupled to the network 28 (e.g., via the controller 14 and/or the infotainment system 24, etc.) such that the vehicle 12 may transmit information to and/or may receive information from various computing devices (e.g., user device 30), databases (e.g., database 32), and/or servers (e.g., server 34) connected to the network 28. In various implementations, the network 28 may include, may be associated with, and/or may be communicatively coupled with one or more remote servers 34. In various implementations, one or more databases (e.g., database 32) may be communicatively coupled to the network 28 and/or the server 34. In some example configurations, the network 28 may include a cloud network, among others.

In various implementations, the user device 30 (e.g., a cell phone, a computer, a laptop, a tablet, etc.) may be communicatively coupled to the vehicle 12 (e.g., the controller 14 and/or the network 28, among others). In various implementations, a user of the user device 30 may include the owner of the vehicle 12. While the system 10 is generally depicted and described herein as including one user device 30, the system 10 may include more than one user device 30.

### Database

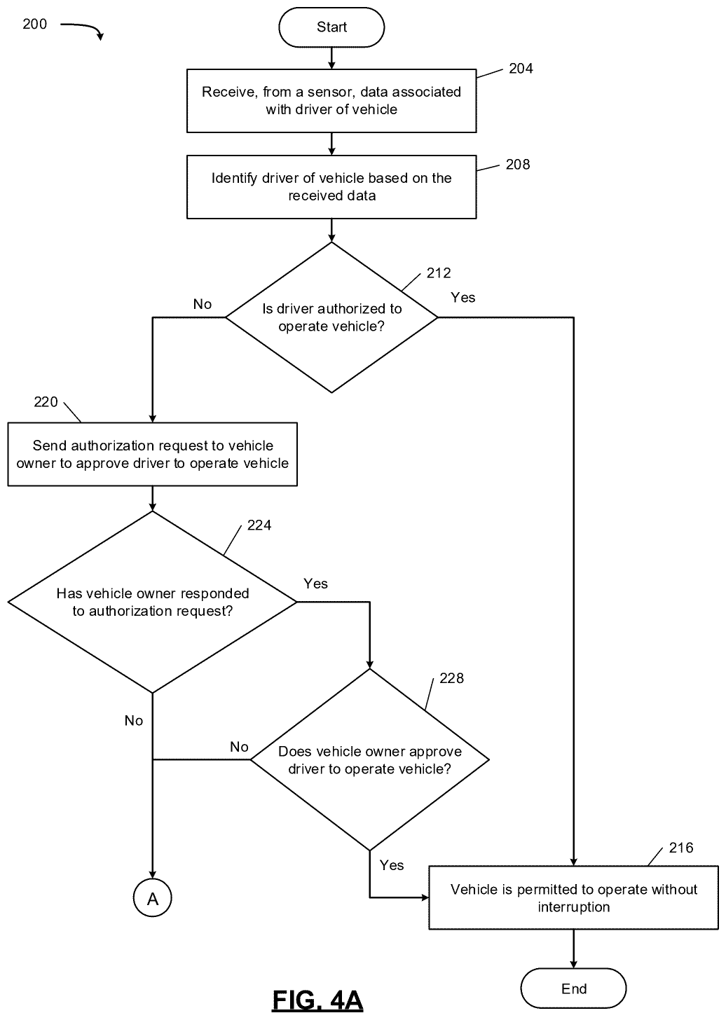

FIG. 3 is a block diagram showing example data structures that may be stored in the database 32. In various implementations, the database 32 may include vehicle owner data 70, authorized driver data 72, unauthorized driver data 74, features of driver data 76, driver fingerprint data 78, passcode data 80, and/or other data 82, among others. In various implementations, the vehicle owner data 70 may include data associated with the owner of the vehicle 12. For example, the vehicle owner data 70 may include name, contact information (e.g., phone number, email, etc.), features 60, and/or fingerprint data, among others.

In various implementations, the authorized driver data 72 may include data associated with a set of drivers who are authorized to operate the vehicle 12. For example, the authorized driver data 72 may include names, contact information, features 60, and/or fingerprint data, among others, associated with the set of drivers who are authorized to operate the vehicle 12. In some examples, the authorized driver data 72 may include a list of authorized drivers.

In various implementations, the unauthorized driver data 74 may include data associated with a set of drivers who are unauthorized to operate the vehicle 12. For example, the unauthorized driver data 74 may include names, contact information, features 60, and/or fingerprint data, among others, associated with the set of drivers who are unauthorized to operate the vehicle 12. In some examples, the unauthorized driver data 74 may include a list of unauthorized drivers. In various implementations, the features of driver data 76 may include data associated with a set of features 60 for each driver of the vehicle 12 (e.g., owner of vehicle, authorized drivers, unauthorized drivers).

In various implementations, the driver fingerprint data 78 may include data associated with at least one fingerprint for each authorized driver of the vehicle 12. In various implementations, the passcode data 80 may include data associated with a passcode for each authorized driver. In various implementations, the other data 82 may be associated with additional data that may be stored in the database 32. In some examples, the database 32 may be disposed in the vehicle 12, in the user device 30, and/or at another location.

### Software Application

With continued reference to FIG. 1, in various implementations, the application 36 may be used to help facilitate authorization of drivers 50 of the vehicle and/or to send notifications and/or authorization requests to the owner of the vehicle 12, among others. In various implementations, the application 36 may be executed via the vehicle 12 (e.g., the controller 14 and/or the infotainment system 24, etc.), the user device 30, and/or the server 34, among others. In various implementations, a user of the application 36 (e.g., the driver 50, the owner, and/or an occupant of the vehicle 12, etc.) may cause, via the application 36, information to be stored in and/or information to be retrieved from the database 32. As will be explained in further details below, a user of the application 36 who is not the owner of the vehicle 12 may request and/or receive authorization from the owner of the vehicle 12 to operate the vehicle 12 via the application 36. In response to receiving authorization from the owner, the vehicle 12 may operate without interruption.

In various implementations, the vehicle 12 (e.g., the controller and/or the infotainment system 24, etc.), the user device 30, and/or the database 32 may store data that indicates the owner of the vehicle 12 and/or drivers of the vehicle 12 who are authorized by the owner to operate the vehicle 12. In various implementations, in response to the owner authorizing a new driver to operate the vehicle 12, the application 36 may cause data associated with the new driver to be stored in the vehicle 12, the user device 30, and/or the database 32.

### Steering Lock System

With continued reference to FIG. 1, in various implementations, the steering lock system 38 may include a steering lock actuator, among others. The steering system 38 may restrict the vehicle 12 from steering when in an activated state (e.g., when the actuator is in a locked configuration) and may permit the vehicle 12 to steer when in a deactivated state (e.g., when the actuator is in an unlocked configuration).

In various implementations, the steering lock system 38 may transmit data and/or information to the controller 14 and/or may receive control signals from the controller 14. In various implementations, the controller 14 may selectively cause the steering lock system 38 to be in the activated state or the deactivated state.

### Flowchart

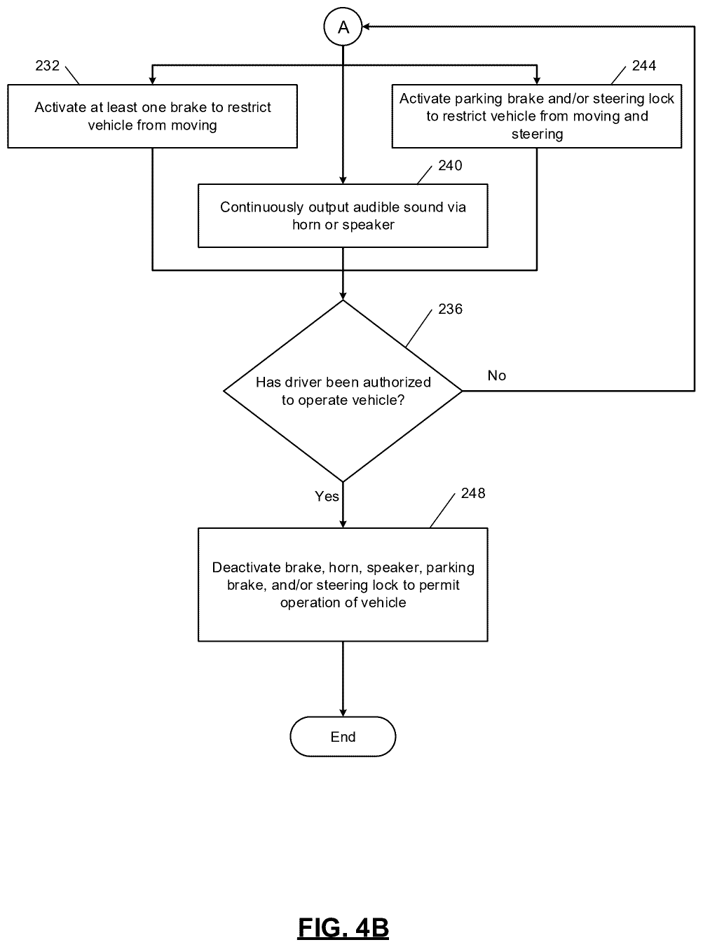

FIGS. 4A and 4B are a flowchart of an example method 200 of operating the system 10. The method 200 may begin at 204. At 204, the controller 14 may receive data associated with a driver 50 of the vehicle 12 from the sensor 22. The method 200 may proceed to 208.

At 208, the controller 14 may identify the driver 50 of the vehicle 12 based on the data from the sensor 22. In various implementations, identifying the driver 50 may include executing facial recognition of the driver 50 via the controller 14. For example, the controller 14 may determine a set of features 60 of the driver 50 based on the data from the sensor 22. In some examples, the set of features 60 may include eye shape, eye color, eye position, nose shape, nose size, mouth shape, mouth size, chin shape, and/or chin size of the driver 50, among others. In response to determining the set of features 60, the controller 14 may send a query request to and/or may query a database (e.g., database 32) to determine if the set of features 60 corresponds to a known driver. In particular, the controller 14 may determine whether the set of features 60 match the features of a driver identified in the database (e.g., a driver identified in the vehicle owner data 70, the authorized driver data 72, and/or the unauthorized driver data 74).

Alternatively, the driver 50 may be identified by the driver 50 providing a passcode to the system 10. For example, the driver 50 may provide the passcode via the infotainment system 24 or the application 36, among others. Additionally, the driver 50 may be identified by providing a fingerprint to the system 10. For example, a fingerprint of the driver 50 may be obtained by scanning, via the sensor 22 or a user device of the driver 50, a finger of the driver 50. The method 200 may proceed to 212.

At 212, in response to identifying the driver 50, the controller 14 may determine if the driver 50 is authorized to operate the vehicle 12. For example, the controller 14 may determine if the driver 50 is an authorized driver or an unauthorized driver. In various implementations, an authorized driver may include the owner of the vehicle or a driver who is approved by the owner to operate the vehicle. An unauthorized driver may include a driver that is not an authorized driver, a driver that is not approved by the owner to operate the vehicle 12, and/or a driver that is unknown to the system 10, among others.

In various implementations, the controller 14 may send a query request to and/or may query a database (e.g., database 32) to determine if the driver 50 is identified in the database as being an authorized driver or an unauthorized driver. If yes at 212 (e.g., in response to determining that the driver is an authorized driver), the method 200 may proceed to 216.

At 216, the controller 14 may permit the vehicle 12 to operate without interruption. Then, the method 200 may end. The method 200 may restart at 204 when a new driver is detected by the system 10 and/or when the vehicle 12 transitions from an off state to an on state. If no at 212 (e.g., in response to determining that the driver is an unauthorized driver), the method 200 may proceed to 220.

At 220, the controller 14 and/or the application 36 may transmit an authorization request to the user device 30 of the owner of the vehicle 12 for the owner to approve the driver 50 to operate the vehicle 12. The authorization request may include the identification of the driver 50 such as an image of the driver 50 captured via the sensor 22. The method 200 may proceed to 224.

At 224, the controller 14 and/or the application 36 may determine if the owner has responded to the authorization request. If yes at 224, the method 200 may proceed to 228. Otherwise, the method 200 may proceed to 232. At 228, the controller 14 and/or the application 36 may determine if the owner accepted the authorization request and approved the driver 50 to operate the vehicle. If yes at 228, the method 200 may proceed to 216. Otherwise, the method 200 may proceed to 232.

At 232, in response to the owner rejecting the authorization request or the owner failing to respond to the authorization request within a determined time period (e.g., 1 min, etc.), the controller 14 may automatically activate the brake system 16 (e.g., at least one brake of the vehicle 12) to restrict the vehicle 12 from moving. In response to the brake system 16 being activated, the controller 14 and/or the application 36 may automatically transmit a notification to and/or display a notification on the user device 30 that the brake system 16 has been activated. Then the method 200 may procced to 236.

In various implementations, the method 200 may proceed to 240 and/or 244, from 224, in addition to or alternative to 232. At 240, in response to the owner rejecting the authorization request or the owner failing to respond to the authorization request within a determined time period (e.g., 1 min, etc.), the controller 14 may automatically activate the horn system 20 by continuously outputting an audible sound via a horn or a speaker of horn system 20. In response to the horn system 20 being activated, the controller 14 and/or the application 36 may automatically transmit a notification to and/or display a notification on the user device 30 that the horn system 20 has been activated. Then the method 200 may procced to 236.

At 244, in response to the owner rejecting the authorization request or the owner failing to respond to the authorization request within a determined time period (e.g., 1 min, etc.), the controller 14 may automatically activate the parking brake system 18 (e.g., a parking brake) to restrict the vehicle 12 from moving and/or the controller 14 may automatically activate the steering lock system 38 (e.g., the steering lock actuator) to restrict the vehicle 12 from steering. In response to the parking brake system 18 and/or the steering lock system 38 being activated, the controller 14 and/or the application 36 may automatically transmit a notification to and/or display a notification on the user device 30 that the parking brake system 18 and/or the steering lock system 38 has been activated. Then the method 200 may procced to 236.

At 236, the controller 14 and/or the application 36 may determine if the owner has approved the driver 50 to operate the vehicle 12. For example, the controller 14 and/or the application 36 may determine if the owner has responded to and/or approved the authorization request. If yes at 236, the method 200 may proceed to 248. Otherwise, the method 200 may end. At 248, the controller 14 may deactivate the brake system 16, the parking brake system 18, the horn system 20, and/or the steering lock system 38 such that the vehicle 12 may operate without interruption. Then the method 200 may end. The method 200 may restart at 204 when a new driver is detected by the system 10 and/or when the vehicle 12 transitions from an off state to an on state.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements.

As noted below, the term “set” generally means a grouping of one or more elements. However, in various implementations a “set” may, in certain circumstances, be the empty set (in other words, the set has zero elements in those circumstances). As an example, a set of search results resulting from a query may, depending on the query, be the empty set. In contexts where it is not otherwise clear, the term “non-empty set” can be used to explicitly denote exclusion of the empty set—that is, a non-empty set will always have one or more elements.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” can be replaced with the term “controller” or the term “circuit.” In this application, the term “controller” can be replaced with the term “module.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); processor hardware (shared, dedicated, or group) that executes code; memory hardware (shared, dedicated, or group) that is coupled with the processor hardware and stores code executed by the processor hardware; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The memory hardware may also store data together with or separate from the code. Shared memory hardware encompasses a single memory device that stores some or all code from multiple modules. One example of shared memory hardware may be level 1 cache on or near a microprocessor die, which may store code from multiple modules. Another example of shared memory hardware may be persistent storage, such as a solid state drive (SSD) or magnetic hard disk drive (HDD), which may store code from multiple modules. Group memory hardware encompasses a memory device that, in combination with other memory devices, stores some or all code from one or more modules. One example of group memory hardware is a storage area network (SAN), which may store code of a particular module across multiple physical devices. Another example of group memory hardware is random access memory of each of a set of servers that, in combination, store code of a particular module. The term memory hardware is a subset of the term computer-readable medium.

The apparatuses and methods described in this application may be partially or fully implemented by a special-purpose computer created by configuring a general-purpose computer to execute one or more particular functions embodied in computer programs. Such apparatuses and methods may be described as computerized or computer-implemented apparatuses and methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special-purpose computer, device drivers that interact with particular devices of the special-purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

The following Clauses provide an exemplary configuration for a system for anti-theft braking and related methods, as described above.

Clause 1: A system comprising: memory hardware configured to store instructions; and processor hardware configured to receive, from a sensor, data associated with a driver of a vehicle and execute the instructions, wherein the instructions include: identifying the driver of the vehicle based on the data; in response to identifying the driver, determining if the driver is an authorized driver or an unauthorized driver; in response to determining that the driver is the unauthorized driver, sending an authorization request to a user device of an owner of the vehicle; and in response to the owner rejecting the authorization request or failing to respond to the authorization request within a determined time period, automatically activating at least one of: a brake of the vehicle to restrict the vehicle from moving, a horn or a speaker of the vehicle, or a steering lock of the vehicle to restrict the vehicle from steering.

Clause 2: The system of clause 1, further comprising the sensor, wherein the sensor is disposed proximate a steering wheel of the vehicle.

Clause 3: The system of clause 1 or 2, wherein: the authorized driver includes the owner of the vehicle or a driver who is approved by the owner to operate the vehicle; and the unauthorized driver includes a driver that is not the authorized driver.

Clause 4: The system of any of clauses 1 through 3, wherein identifying the driver of the vehicle includes: determining a set of features of the driver based on the data, the set of features includes at least one of: eye shape, eye color, eye position, nose shape, nose size, mouth shape, mouth size, chin shape, or chin size of the driver; and querying a database to determine if the set of features corresponds to a known driver.

Clause 5: The system of any of clauses 1 through 4, wherein the instructions include, in response to determining that the driver is the authorized driver, permitting the vehicle to operate without interruption.

Clause 6: The system of any of clauses 1 through 5, wherein the instructions include, in response to the owner rejecting the authorization request or failing to respond to the authorization request within a determined time period, automatically activating the horn or the speaker of the vehicle, wherein activating the horn or the speaker includes continuously outputting an audible sound via the horn or the speaker.

Clause 7: The system of any of clauses 1 through 6, wherein the instructions include, in response to the owner rejecting the authorization request or failing to respond to the authorization request within a determined time period, automatically activating a parking brake of the vehicle to restrict the vehicle from moving.

Clause 8: The system of any of clauses 1 through 7, wherein the instructions include, in response to the owner rejecting the authorization request or failing to respond to the authorization request within a determined time period, automatically activating the steering lock of the vehicle to restrict the vehicle from steering.

Clause 9: The system of any of clauses 1 through 8, wherein the processor hardware is configured to receive, from the user device, authorization for the driver to operate the vehicle, and wherein the instructions include, in response to receiving the authorization, automatically deactivating the at least one of: the brake of the vehicle, the horn or the speaker of the vehicle, or the steering lock of the vehicle.

Clause 10: The system of clause 9, wherein the instructions include, in response to receiving the authorization: automatically updating an authorized driver list to include the driver; and storing the authorized driver list in a database.

Clause 11: A vehicle comprising: the system of any of clauses 1 through 10.

Clause 12: A computer-implemented method comprising: receiving, from a sensor, data associated with a driver of a vehicle; identifying the driver of the vehicle based on the data; in response to identifying the driver, determining if the driver is an authorized driver or an unauthorized driver; in response to determining that the driver is the unauthorized driver, sending an authorization request to a user device of an owner of the vehicle; and in response to the owner rejecting the authorization request or failing to respond to the authorization request within a determined time period, automatically activating at least one of: a brake of the vehicle to restrict the vehicle from moving, a horn or a speaker of the vehicle, or a steering lock of the vehicle to restrict the vehicle from steering.

Clause 13: The computer-implemented method of clause 12, wherein: the authorized driver includes the owner of the vehicle or a driver who is approved by the owner to operate the vehicle; and the unauthorized driver includes a driver that is not the authorized driver.

Clause 14: The computer-implemented method of clause 12 or 13, wherein identifying the driver of the vehicle includes: determining a set of features of the driver based on the data, the set of features includes at least one of: eye shape, eye color, eye position, nose shape, nose size, mouth shape, mouth size, chin shape, or chin size of the driver; and querying a database to determine if the set of features corresponds to a known driver.

Clause 15: The computer-implemented method of any of clauses 12 through 14, further comprising, in response to determining that the driver is the authorized driver, permitting the vehicle to operate without interruption.

Clause 16: The computer-implemented method of any of clauses 12 through 15, further comprising, in response to the owner rejecting the authorization request or failing to respond to the authorization request within a determined time period, automatically activating the horn or the speaker of the vehicle, wherein activating the horn or the speaker includes continuously outputting an audible sound via the horn or the speaker.

Clause 17: The computer-implemented method of any of clauses 12 through 16, further comprising, in response to the owner rejecting the authorization request or failing to respond to the authorization request within a determined time period, automatically activating a parking brake of the vehicle to restrict the vehicle from moving.

Clause 18: The computer-implemented method of any of clauses 12 through 17, further comprising, in response to the owner rejecting the authorization request or failing to respond to the authorization request within a determined time period, automatically activating the steering lock of the vehicle to restrict the vehicle from steering.

Clause 19: The computer-implemented method of any of clauses 12 through 18, further comprising: receiving, from the user device, authorization for the driver to operate the vehicle; and in response to receiving the authorization, automatically deactivating the at least one brake to permit the vehicle to operate without interruption.

Clause 20: The computer-implemented method of clause 19 further comprising, in response to receiving the authorization: automatically updating an authorized driver list to include the driver; and storing the authorized driver list in a database.

1. A system comprising:
memory hardware configured to store instructions; and
processor hardware configured to receive, from a sensor, data associated with a driver of a vehicle and execute the instructions, wherein the instructions include:
identifying the driver of the vehicle based on the data;
in response to identifying the driver, determining if the driver is an authorized driver or an unauthorized driver;
in response to determining that the driver is the unauthorized driver, sending an authorization request to a user device of an owner of the vehicle; and
in response to the owner rejecting the authorization request or failing to respond to the authorization request within a determined time period, automatically activating at least one of:
a brake of the vehicle to restrict the vehicle from moving,
a horn or a speaker of the vehicle, or
a steering lock of the vehicle to restrict the vehicle from steering.

2. The system of claim 1 further comprising the sensor, wherein the sensor is disposed proximate a steering wheel of the vehicle.

3. The system of claim 1 wherein:
the authorized driver includes the owner of the vehicle or a driver who is approved by the owner to operate the vehicle; and
the unauthorized driver includes a driver that is not the authorized driver.

4. The system of claim 1 wherein identifying the driver of the vehicle includes:
determining a set of features of the driver based on the data, the set of features includes at least one of: eye shape, eye color, eye position, nose shape, nose size, mouth shape, mouth size, chin shape, or chin size of the driver; and
querying a database to determine if the set of features corresponds to a known driver.

5. The system of claim 1 wherein the instructions include, in response to determining that the driver is the authorized driver, permitting the vehicle to operate without interruption.

6. The system of claim 1 wherein the instructions include, in response to the owner rejecting the authorization request or failing to respond to the authorization request within a determined time period, automatically activating the horn or the speaker of the vehicle, wherein activating the horn or the speaker includes continuously outputting an audible sound via the horn or the speaker.

7. The system of claim 1 wherein the instructions include, in response to the owner rejecting the authorization request or failing to respond to the authorization request within a determined time period, automatically activating a parking brake of the vehicle to restrict the vehicle from moving.

8. The system of claim 1 wherein the instructions include, in response to the owner rejecting the authorization request or failing to respond to the authorization request within a determined time period, automatically activating the steering lock of the vehicle to restrict the vehicle from steering.

9. The system of claim 1 wherein the processor hardware is configured to receive, from the user device, authorization for the driver to operate the vehicle, and wherein the instructions include, in response to receiving the authorization, automatically deactivating the at least one of:
the brake of the vehicle,
the horn or the speaker of the vehicle, or
the steering lock of the vehicle.

10. The system of claim 9 wherein the instructions include, in response to receiving the authorization:
automatically updating an authorized driver list to include the driver; and
storing the authorized driver list in a database.

11. A vehicle comprising:
the system of claim 1.

12. A computer-implemented method comprising:
receiving, from a sensor, data associated with a driver of a vehicle;
identifying the driver of the vehicle based on the data;
in response to identifying the driver, determining if the driver is an authorized driver or an unauthorized driver;
in response to determining that the driver is the unauthorized driver, sending an authorization request to a user device of an owner of the vehicle; and
in response to the owner rejecting the authorization request or failing to respond to the authorization request within a determined time period, automatically activating at least one of:
a brake of the vehicle to restrict the vehicle from moving,
a horn or a speaker of the vehicle, or
a steering lock of the vehicle to restrict the vehicle from steering.

13. The computer-implemented method of claim 12 wherein:
the authorized driver includes the owner of the vehicle or a driver who is approved by the owner to operate the vehicle; and
the unauthorized driver includes a driver that is not the authorized driver.

14. The computer-implemented method of claim 12 wherein identifying the driver of the vehicle includes:
determining a set of features of the driver based on the data, the set of features includes at least one of: eye shape, eye color, eye position, nose shape, nose size, mouth shape, mouth size, chin shape, or chin size of the driver; and
querying a database to determine if the set of features corresponds to a known driver.

15. The computer-implemented method of claim 12 further comprising, in response to determining that the driver is the authorized driver, permitting the vehicle to operate without interruption.

16. The computer-implemented method of claim 12 further comprising, in response to the owner rejecting the authorization request or failing to respond to the authorization request within a determined time period, automatically activating the horn or the speaker of the vehicle,
wherein activating the horn or the speaker includes continuously outputting an audible sound via the horn or the speaker.

17. The computer-implemented method of claim 12 further comprising, in response to the owner rejecting the authorization request or failing to respond to the authorization request within a determined time period, automatically activating a parking brake of the vehicle to restrict the vehicle from moving.

18. The computer-implemented method of claim 12 further comprising, in response to the owner rejecting the authorization request or failing to respond to the authorization request within a determined time period, automatically activating the steering lock of the vehicle to restrict the vehicle from steering.

19. The computer-implemented method of claim 12 further comprising:
receiving, from the user device, authorization for the driver to operate the vehicle; and
in response to receiving the authorization, automatically deactivating the at least one brake to permit the vehicle to operate without interruption.

20. The computer-implemented method of claim 19 further comprising, in response to receiving the authorization:
automatically updating an authorized driver list to include the driver; and
storing the authorized driver list in a database.
